(19) United States
(12) Patent Application Publication
(10) Pub. No.: US 2026/0234909 A1
(43) Pub. Date: Aug. 13, 2026

(54) SYSTEM FOR OPERATING CLAMP AXIS OF AN INJECTION MOLDING MACHINE AND METHOD THEREOF

(71) Applicant: MILACRON MARKETING COMPANY LLC, Batavia, OH (US)

(72) Inventors: Hardik M. PATEL, Ahmedabad (IN); Vinod J. Patel, Ahmedabad (IN); Atin TANDON, Indianapolis, IN (US)

(21) Appl. No.: 19/537,294

(22) Filed: Feb. 11, 2026

(30) Foreign Application Priority Data
Feb. 13, 2025 (IN) 202521012313

(51) Int. Cl. E02F 9/22; B29C 45/17; B29C 45/67; G05D 7/06

(52) U.S. Cl. CPC E02F 9/2292; B29C 45/17; B29C 45/1761; B29C 45/6728; G05D 7/0635; B29C 2945/76568; F15B 2211/20553

(57) ABSTRACT

A system for operating a clamp axis of an injection molding machine, comprising a human-machine interface configured to communicate operating parameters of the injection molding machine; a machine control unit receives the operating parameters from the human-machine interface, the machine control unit configured to transmit a controlling signals to a fluid power pack and/or a proportional flow valve; and an actuator actuated based on the controlling signals received by the fluid power pack and the proportional flow valve, to reciprocate the clamp axis in linear direction. The system is configured to toggle from a normal mode to eco-mode and vice versa by means of the human-machine interface. The absolute power demand during operation of the clamp axis is reduced by 15%-30%.

### CROSS-REFERENCE TO RELATED APPLICATION

This application claims priority from India Patent Application No. 202521012313, filed Feb. 13, 2025, which is also incorporated herein by reference in its entirety.

### FIELD OF INVENTION

The present invention relates to an injection molding machine. More specifically, the present invention relates to a system for operating a clamp axis of the injection molding machine in an energy efficient manner.

### BACKGROUND OF INVENTION

Generally, in an injection molding machine a clamp axis is for building the clamping force in the process of producing the end products in the injection molding machine.

The clamp axis is moved forward & retract through a hydraulic actuator which includes a cylinder but not limited to Single acting or Double acting cylinder or telescopic cylinder. The movement of said hydraulic actuator is controlled by either a proportional flow valve or a direction control flow valve or both, directing the oil supplied from the hydraulic powerpack which includes a hydraulic pump, a motor, and a variable speed drive. An HMI controller gives the electronic signal commands to the hydraulic powerpack for generating oil flow to pass through hydraulic flow valves to actuate the said hydraulic actuator for moving said clamp axis in both directions.

Generally, the direction control flow valve also known as ON-OFF valve or Bang-Bang valve, which is a fixed solenoid actuated spring-operated valve, working only at two operating points i.e., either at regulation of 0% or at 100%. The direction control flow valve during movements of the clamp axis always remains at 100% regulation, it keeps very small load demand in terms of oil pressure or torque and oil flow at said hydraulic powerpack. This keeps lower energy demand in the injection molding machine. However, a significant drawback here is, the position and speed control of the clamp axis sees a limitation in terms of poor accuracy like overriding the targeted position, hard braking of speed increasing the vibrations in the machine, higher chances of cavitation in hydraulic lines. Hence, this is not preferred for the application where high accuracy of position & speed is a priority. Also, it contains a threat to damage the die or mold installed on the Clamp axis, especially the ones which has delicate parts in it.

To overcome the above drawbacks, the proportional flow valve is utilised instead of the direction control flow valve. The proportional flow valve which unlike the direction control flow valve work at multiple operating points between 0% & 100% regulation. Generally, the closed loop proportional flow valve are made of, a valve body which encapsules a spool, a proportional operated solenoid and an LVDT (Linear variable differential transformer) or a position transducer for measuring position of spool as well as an Electronic Driver which can be OBE (Onboard electronics) or Off-board as stand alone. Based on the user settings, the HMI controller gives electronic signal command to the electronic driver, which processes this signal & generates final output to energize said proportional operated solenoid which actuates the spool through spring mechanism. The LVDT measures actual position of this spool and gives feedback of the measured position to the electronic driver which close loops it with the given final output. The other version of proportional flow valve is Open loop which has same construction like closed loop proportional flow valve explained above, except it doesn't have any LVDT or position transducer for measuring position of spool. It means it works at multiple operating points but with no feedback on position of spool. This kind of proportional valves have little poor accuracy compared to closed loop proportional valve. With the above said proportional flow valves, especially with closed loop proportional flow valves the accuracy during controlling position and speed of the clamp axis remains superior due to multi-position and closed-loop actuation of said spool through the proportional operated solenoid which is controlled by said electronic driver. Hence it makes it ideal for the die/molds which need higher accuracy on position and speed. However, with this, the energy consumption remains higher since, due to multi-position operation of spool the pressure on the pump, torque on the motor and current on the drive in the hydraulic powerpack, remains higher during operation of said clamp axis.

Many a times, the machine processors or end users run different kinds of die/molds. Some require higher position accuracy and hence suitable to go with the proportional flow valve. Some do not need higher position accuracy; consequently, providing an opportunity to save energy by using direction control flow valve. This often creates a dilemma for machine processors between driving the clamp axis through the proportional flow valve or through the direction control flow valve.

There are many processors and mold makers who uses both kind of molds and would like to utilize the right combination for each mold i.e., the clamp axis driven through the proportional flow valve and the clamp axis driven through the direction control flow valve. However, it is not possible to accommodate both the solution on one clamp axis or becomes very expensive if both valves are used on a machine followed by a switchable solution to switch between both valves. Hence, it becomes a limitation for the machine user to go with only one choice out of both options.

Therefore, there is need in the art to provide a system which has fair position and speed accuracy in controlling the clamp axis, like with proportional flow valve and the system is also energy efficient which runs clamp axis at lower energy demands like the direction control flow valve.

### OBJECTIVE OF INVENTION

An object of the present invention is to provide a system and a method for operating a clamp axis.

Another object of the present invention is to provide a system and a method for operating a clamp axis which utilizes a proportional flow valve having high position and speed accuracy in controlling the clamp axis.

Further object of the present invention is to provide a system and a method for operating a clamp axis having the proportional flow valve for controlling the clamp axis which is energy efficient as or better than the system having a direction control flow valve.

### SUMMARY OF INVENTION

A system for operating a clamp axis of an injection molding machine using a proportional flow valve and is capable of being toggling between an eco-mode and a normal mode.

The clamp axis can be reciprocated linearly in a fore and aft direction by means of an actuator which includes but not limited to Single acting or Double acting cylinder or telescopic cylinder. The actuator is a fluid actuator. The fluid actuator can be a hydraulic actuator or a pneumatic actuator. The actuator is controlled by means of the proportional flow valve. The proportional flow valve directing the fluid supplied from the fluid power pack. A human-machine interface communicates an input to a machine control unit. The machine control unit generates and transmits the controlling signal to the fluid power pack for generating the fluid flow to pass through the proportional flow valve to actuate the actuator for reciprocating the clamp axis.

The proportional flow valve comprises a proportional flow valve body which encapsules a spool, a proportional operated solenoid, and an LVDT or position transducer for measuring position of the spool as well as an electronic driver which can be on-board as OBE (Onboard electronics) or Off-board as stand alone. Based on the user settings, the human-machine interface through the machine control unit transmits the controlling signal to the electronic driver. The electronic driver, based on the received controlling signal, generates a final output to energize the proportional operated solenoid which actuates the spool through the spring mechanism. The LVDT measures actual position of the spool and provides feedback of the measured position to the electronic driver which close loops it with the given final output.

A user inputs the operating condition and toggles to the normal mode by means of the human-machine interface. The input can be setting an operating velocity in which the clamp axis to be operated, by means of the human-machine interface.

The machine control unit generates a pre-set profile of an acceleration and a displacement by means of v=SQRT(2×a×s), where “v” is velocity “a” is acceleration & “s” is the position, of clamp axis. A linearized profile of the clamp axis is generated based on the pre-set profile by means of the machine control unit. Subsequently, a linear interpolation of the linearized profile is performed by means of the machine control unit and a first controlling signal is sent to the proportional flow valve for generating the fluid flow to pass through the proportional flow valve to actuate the actuator for reciprocating the clamp axis. Simultaneously, a derived controlling signal derived from the first controlling signal is sent to the fluid power pack for accurately controlling the speed and position of the clamp axis. The derived controlling signal to powerpack=The derived control signal×a fixed factor which can range from 0.1 to 10.

When the eco-mode is selected and a user inputs the operating condition by means of the human-machine interface. In an embodiment, the input can be setting an operating velocity in which the clamp axis to be operated, by means of the human-machine interface. As depicted in the FIG. 10, the machine control unit generates a pre-set profile of an acceleration and a displacement by means of v=SQRT(2×a×s), where “v” is velocity “a” is acceleration & “s” is the position, of clamp axis. The formula v=SQRT(2×a×s) is the third equation of motion. A first linearized profile of the clamp axis is generated based on the pre-set profile by means of the machine control unit for proportional control valve and simultaneously a second linearized profile of the clamp axis is generated based on the pre-set profile by means of the machine control unit for fluid power pack. Subsequently, a first linear interpolation of the first linearized profile, and a second linear interpolation of the second linearized profile are performed by means of the machine control unit, and a first controlling signal and a second controlling signal are generated and sent to the proportional flow valve and the fluid power pack, respectively, for generating the fluid flow to pass through the proportional flow valve to actuate the actuator for reciprocating the clamp axis and for accurately controlling the speed and position of the clamp axis in an energy efficient manner.

The present invention reduces the absolute power demand during operating of the clamp axis by 15%-30%. Thereby, the average connected load of the injection molding machine can also be brought down which reduces the burden on fixed power demand of a factory.

### BRIEF DESCRIPTION OF DRAWINGS

FIG. 1 depicts a system for operating a clamp axis of an injection molding machine using a direction control flow valve.

FIG. 2 shows a cross-sectional view of the direction control flow valve.

FIG. 3 shows a symbolic representation of the direction control flow valve.

FIG. 4 shows the operational process of the system as depicted in FIG. 1.

FIG. 5 depicts a system for operating a clamp axis of an injection molding machine using a proportional flow valve.

FIG. 6 shows a cross-sectional view of the proportional flow valve.

FIG. 7 shows a symbolic representation of the proportional flow valve.

FIG. 8 shows the operational process of the system as depicted in FIG. 5.

FIG. 9 depicts a system for operating a clamp axis of an injection molding machine using a proportional flow valve according to the present invention.

FIG. 10 shows the operational process of the system according to the present invention.

FIG. 11 shows graph of power consumption during mold opening and mold closing operation of the system of FIG. 5.

FIG. 12 shows graph of power consumption during mold opening and mold closing operation of the present invention as shown in FIG. 9.

FIG. 13A shows the linearization to the flow valve and the power pack, of the system shown in FIG. 1.

FIG. 13B shows the linearization to the flow valve and the power pack, of the system shown in FIG. 5.

FIG. 13C shows the linearization to the flow valve and the power pack, of the system shown in FIG. 9.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention.

### DETAILED DESCRIPTION OF INVENTION

The present invention as embodied by “system for operating clamp axis of an injection molding machine and method thereof” succinctly fulfils the above-mentioned need(s) in the art. The present invention has objective(s) arising as a result of the abovementioned need(s), said objective(s) being enumerated below. In as much as the objective(s) of the present invention are enumerated, it will be obvious to a person skilled in the art that, the enumerated objective(s) are not exhaustive of the present invention in its entirety, and are enclosed solely for the purpose of illustration. Further, the present invention encloses within its scope and purview, any structural alternative(s) and/or any functional equivalent(s) even though, such structural alternative(s) and/or any functional equivalent(s) are not mentioned explicitly herein or elsewhere, in the present disclosure. The present invention therefore encompasses also, any improvisation(s)/modification(s) applied to the structural alternative(s)/functional alternative(s) within its scope and purview. The present invention may be embodied in other specific form(s) without departing from the scope or essential attributes thereof.

Throughout this specification, the use of the word “comprise” and variations such as “comprises” and “comprising” may imply the inclusion of an element or elements not specifically recited.

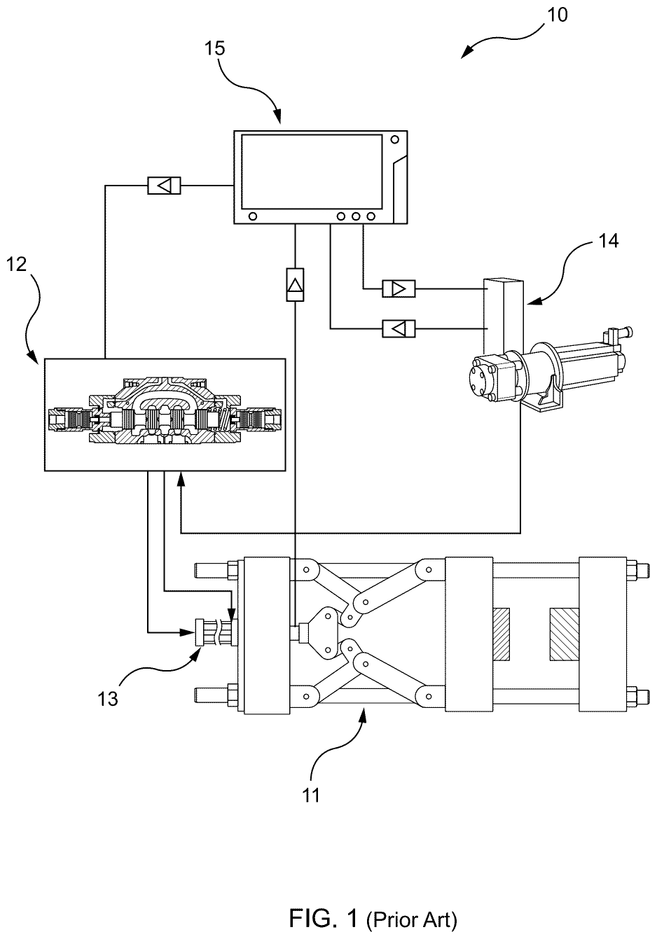

FIGS. 1-8 show a system and a method employed in general. The FIG. 1 shows a system (10) for operating a clamp axis (11) of an injection molding machine using a direction control flow valve (12).

The clamp axis (11) can be reciprocated linearly in a fore and aft direction by means of an actuator (13) which includes but not limited to Single acting or Double acting cylinder or telescopic cylinder. The actuator (13) is a fluid actuator. The fluid actuator (13) can be a hydraulic actuator or a pneumatic actuator. The actuator (13) is controlled by means of the direction control flow valve (12). The direction control flow valve (12) directing the fluid supplied from a fluid power pack (14). The fluid power pack (14) includes a pump, a motor, and a variable speed drive. A human-machine interface (15) communicates an input to a machine control unit. The machine control unit generates and transmits a controlling signal to the fluid power pack (14) for generating a fluid flow to pass through the direction control flow valve (12) to actuate the actuator for reciprocating the clamp axis (11).

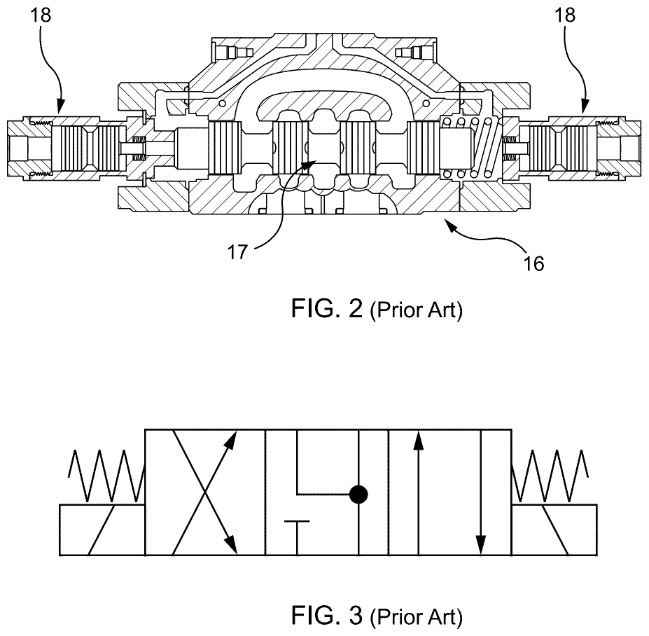

FIG. 2 shows the cross-sectional view of the direction control flow valve (12). The direction control flow valve (12) comprising of a valve body (16), a spool (17) for directing the oil flow and a fixed operated solenoids (18) to actuate the spool (7) through a spring force. The direction control flow valve (12) during movements of said clamp axis (11) always remains at 100% regulation. The system (10) having the direction control flow valve (12) requires very small load demand in terms of fluid pressure or torque and fluid flow at the fluid power pack (14). This keeps lower energy demand in the injection molding machine. However, the system (10) has poor accuracy in terms of position and speed control of the clamp axis (11).

FIG. 3 shows a symbolic representation of the direction control flow valve.

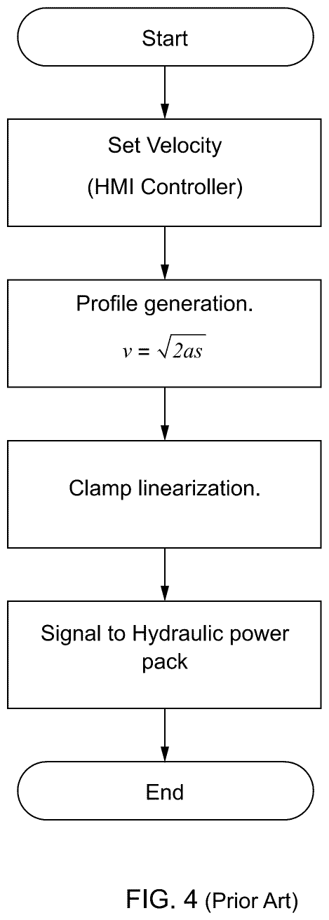

FIG. 4 shows a process flow of the system (10) having the direction control flow valve (12). A user inputs the operating condition by means of the human-machine interface (15). In an embodiment, the input can be setting an operating velocity in absolute or % at which the clamp axis to be operated, by means of the human-machine interface (15).

The machine control unit generates a pre-set profile of an acceleration and a displacement by means of v=SQRT(2×a×s), where “v” is velocity “a” is acceleration & “s” is the position, of clamp axis. The formula is v=SQRT(2×a×s) is the third equation of motion. A linearized profile of the clamp axis is generated based on the pre-set profile by means of the machine control unit, and a controlling signal is sent to the fluid power pack (14) for generating the fluid flow to pass through the direction control flow valve (12) to actuate the actuator for reciprocating the clamp axis (11).

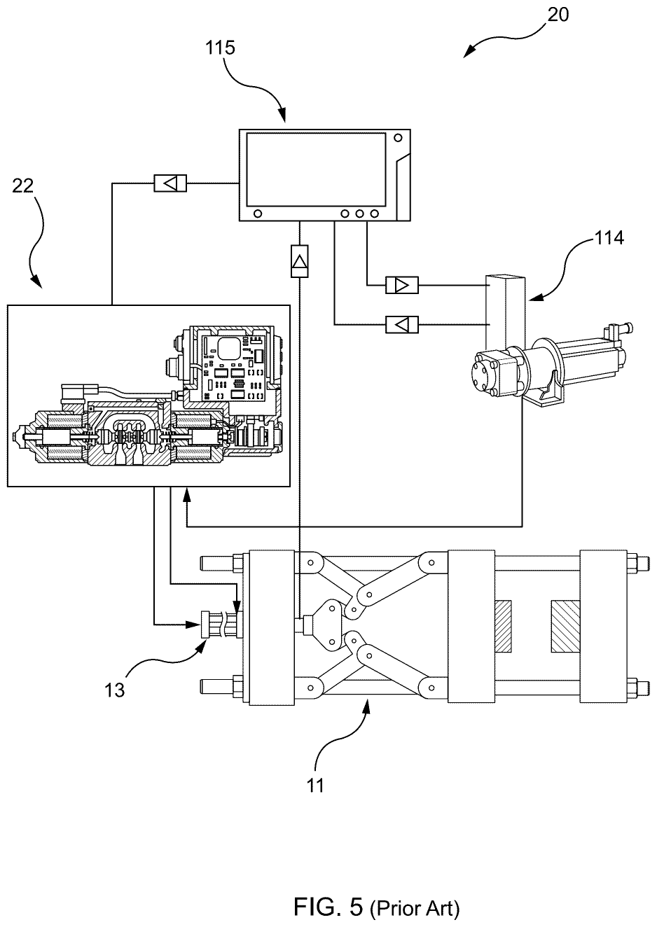

The FIG. 5 shows a system (20) for operating the clamp axis (11) of an injection molding machine using a proportional flow valve (22).

The clamp axis (11) can be reciprocated linearly in a fore and aft direction by means of the actuator (13) which includes but not limited to Single acting or Double acting cylinder or telescopic cylinder. The actuator (13) is a fluid actuator. The fluid actuator (13) can be a hydraulic actuator or a pneumatic actuator. The actuator (13) is controlled by means of the proportional flow valve (22). The proportional flow valve (22) directing the fluid supplied from the fluid power pack (114). The human-machine interface (115) communicates an input to a machine control unit. The machine control unit generates and transmits the controlling signal to the fluid power pack (114) for generating the fluid flow to pass through the proportional flow valve (22) to actuate the actuator for reciprocating the clamp axis (11).

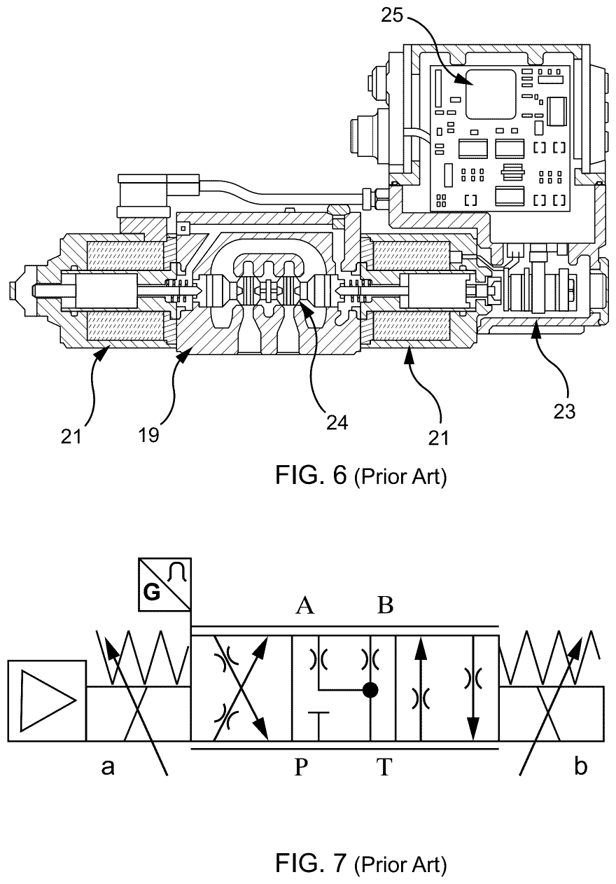

The FIG. 6 shows a cross-sectional view of the proportional flow valve (22). The proportional flow valve (22) comprises a proportional flow valve body (19) which encapsules a proportional flow valve spool (24), a proportional operated solenoid (21), and an LVDT (23) or position transducer for measuring position of the proportional flow valve spool (24) as well as an electronic driver (25) which can be on-board as OBE (Onboard electronics) or Off-board as stand alone. Based on the user settings, the human-machine interface (115) through the machine control unit transmits the controlling signal command to the electronic driver (25). The electronic driver (25), based on the received controlling signal, generates a final output to energize the proportional operated solenoid (21) which actuates the proportional flow valve spool (24) through the spring mechanism. The LVDT (23) measures actual position of the proportional flow valve spool (24) and provides feedback of the measured position to the electronic driver (25) which close loops it with the given final output.

FIG. 7 shows a symbolic representation of the proportional flow valve (22).

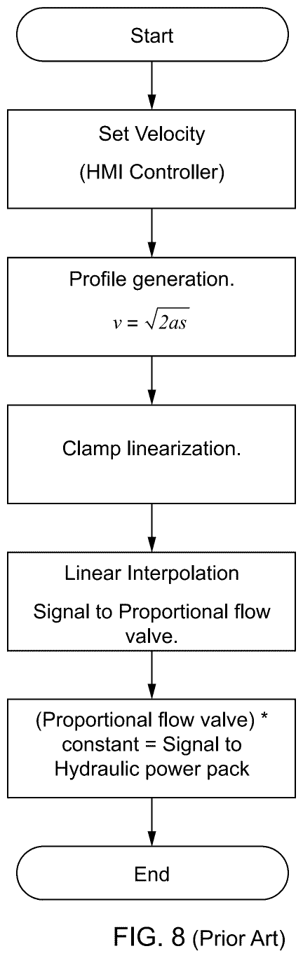

FIG. 8 shows a process flow of the system (20) having the proportional flow valve (22). A user inputs the operating condition by means of the human-machine interface (115). In an embodiment, the input can be setting an operating velocity in which the clamp axis to be operated, by means of the human-machine interface (115).

The machine control unit generates a pre-set profile of an acceleration and a displacement by means of v=SQRT(2×a×s), where “v” is velocity “a” is acceleration & “s” is the position, of clamp axis. The formula v=SQRT(2×a×s) is the third equation of motion. A linearized profile of the clamp axis is generated based on the pre-set profile by means of the machine control unit. Subsequently, a linear interpolation of the linearized profile is performed by means of the machine control unit and a first controlling signal is sent to the proportional flow valve (22) for generating the fluid flow to pass through the proportional flow valve (22) to actuate the actuator for reciprocating the clamp axis (11). Simultaneously, a derived controlling signal derived from the first controlling signal is sent to the fluid power pack (14) for accurately controlling the speed and position of the clamp axis (11). The derived controlling signal to powerpack (114) is equal to the derived control signal multiplied by a fixed factor which can range from 0.1 to 10.

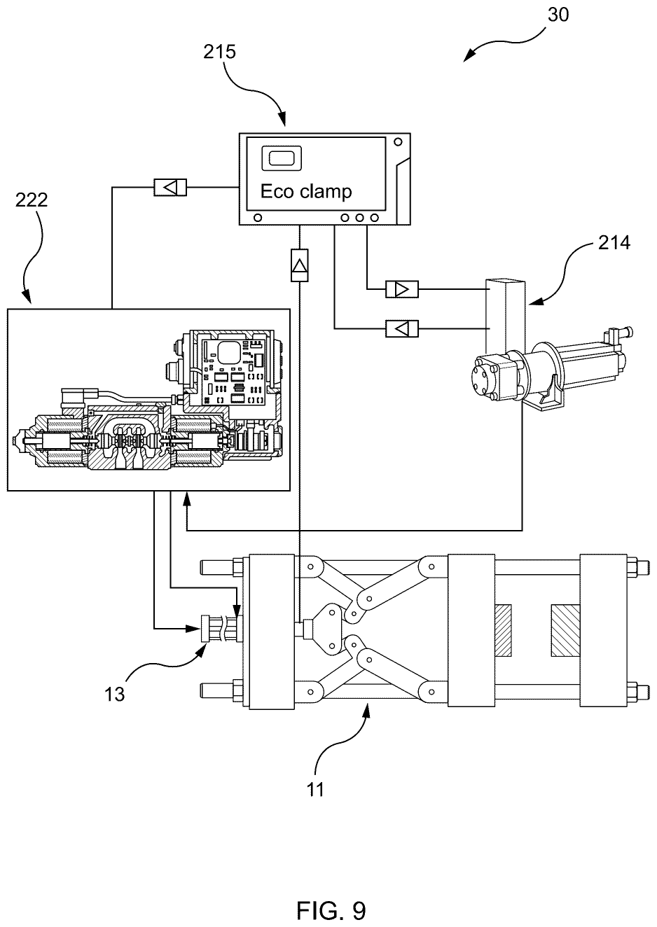

The FIG. 9 shows a system (30) for operating the clamp axis (11) of an injection molding machine using the proportional flow valve (222) and is capable of being toggling between an eco-mode and a normal mode.

The system (30) for operating the clamp axis (11) of the present invention is similar to the system (20) for operating the clamp axis (11) of an injection molding machine using the proportional flow valve (222), in terms of constructional arrangement.

The system (30) is capable of being toggled to the eco-mode from the normal mode and vice-versa by means of the human-machine interface (215). When the normal mode is selected, the system adopts the process flow as depicted in the FIG. 8.

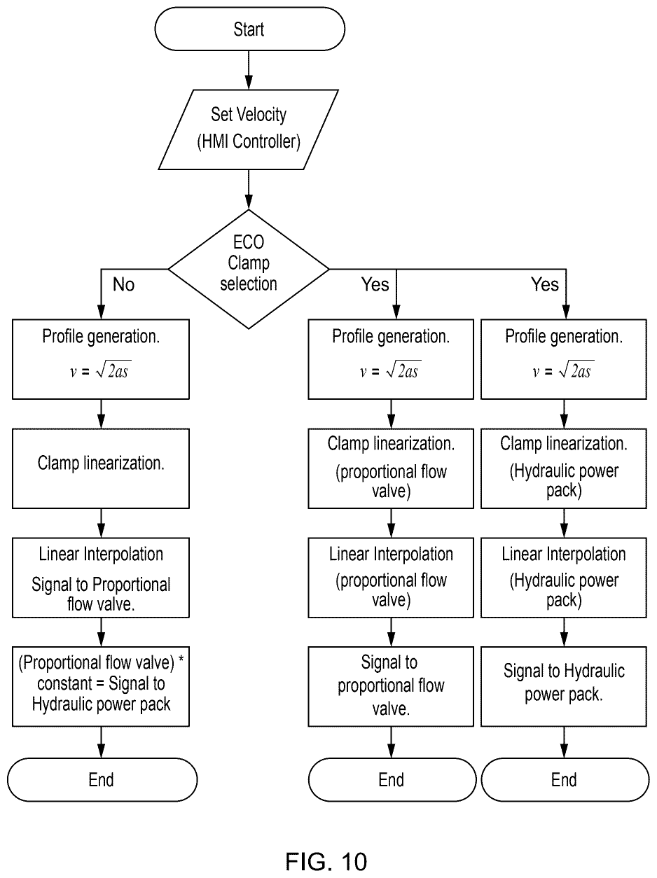

When the eco-mode is selected and a user inputs the operating condition by means of the human-machine interface (215). In an embodiment, the input can be setting an operating velocity in which the clamp axis to be operated, by means of the human-machine interface (215). As depicted in the FIG. 10, the machine control unit generates a pre-set profile of an acceleration and a displacement by means of v=SQRT(2×a×s), where “v” is velocity “a” is acceleration & “s” is the position, of clamp axis. The formula v=SQRT(2×a×s) is the third equation of motion. A first linearized profile of the clamp axis is generated based on the pre-set profile by means of the machine control unit for proportional control valve (222) and simultaneously a second linearized profile of the clamp axis is generated based on the pre-set profile by means of the machine control unit for fluid power pack (214). Subsequently, a first linear interpolation of the first linearized profile, and a second linear interpolation of the second linearized profile are performed by means of the machine control unit, and a first controlling signal and a second controlling signal are generated and sent to the proportional flow valve (222) and the fluid power pack (214), respectively, for generating the fluid flow to pass through the proportional flow valve (222) to actuate the actuator (13) for reciprocating the clamp axis (11) and for accurately controlling the speed and position of the clamp axis (11) in an energy efficient manner.

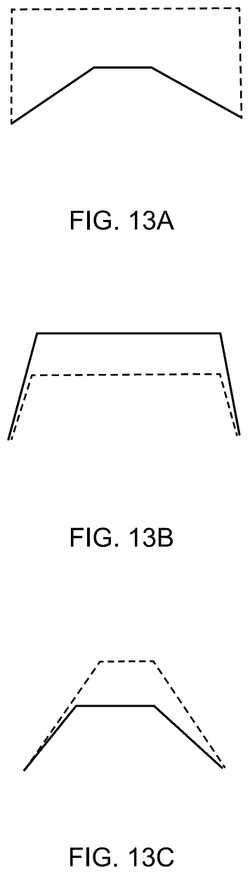

FIGS. 13A, 13B and 13C shows the linearization to the flow valve (12, 22, 222) and the power pack (14, 114, 214), of the system shown in FIGS. 1, 5 and 9. The linearization as shown in red lines corresponds to the linearization to the flow valve (12, 22, 222) and in blue line corresponds to the linearization to the power pack (14, 114, 214).

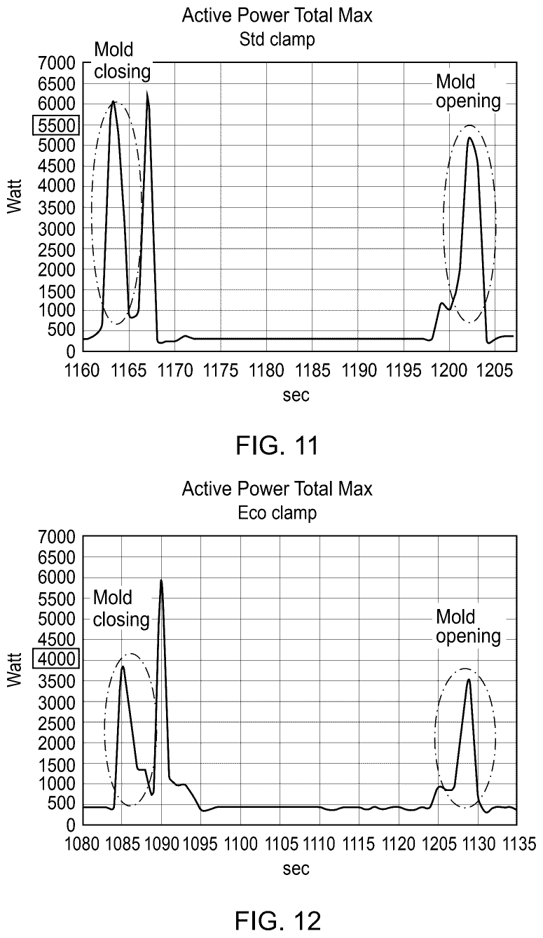

FIG. 11 shows the power consumption during mold opening and mold closing operation for the system of FIG. 5. FIG. 12 shows the power consumption during mold opening and mold closing operation for the system of the present invention as shown in FIG. 9. The present invention reduces the absolute power demand during operating of the clamp axis (11) by 15% 30%.

It will be appreciated by those skilled in the art that the disclosure is not restricted in its use to the particular application or applications described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope as set forth and defined by the following claims.

1. A system for operating a clamp axis of an injection molding machine, comprising,
a human-machine interface configured to communicate an operating parameter of the injection molding machine;
a machine control unit for receiving the operating parameter from the human-machine interface, the machine control unit configured to transmit controlling signals to at least one of a fluid power pack and a proportional flow valve; and
an actuator actuated based on the controlling signals received by the at least one of the fluid power pack and the proportional flow valve, to reciprocate the clamp axis in a linear direction,
wherein the system is configured to toggle from a normal mode to an eco-mode and vice versa by means of the human-machine interface.

2. The system as claimed in claim 1, wherein,
when the eco-mode is selected, the machine control unit transmits a first controlling signal to the proportional flow valve and a second controlling signal to the fluid power pack, and
when the normal mode is selected, the machine control unit transmits the first controlling signal to the proportional flow valve and a derived controlling signal to the fluid power pack.

3. The system as claimed in claim 1, wherein the fluid power pack comprises a fluid pump, a motor and a variable speed drive.

4. The system as claimed in claim 2, wherein the machine control unit based on the operating parameter generates a pre-set profile.

5. The system as claimed in claim 4, wherein the operating parameter is an operating velocity.

6. The system as claimed in claim 5, wherein based on the operating velocity the machine control unit generates the pre-set profile of an acceleration and a displacement by means of a formula v=SQRT(2×a×s), where “v” is a velocity, “a” is an acceleration and “s” is a position of the clamp axis.

7. The system as claimed in claim 4, wherein the machine control unit linearizes and interpolates the pre-set profile to generate the first controlling signal, the second controlling signal or the derived controlling signal transmitted to the at least one of the fluid power pack and the proportional flow valve.

8. A method of operating a clamp axis of an injection molding machine, comprising,
inputting an operating parameter by means of a human-machine interface;
generating a pre-set profile by means of a machine control unit;
linearizing and interpolating the pre-set profile to generate controlling signals;
transmitting the controlling signals to at least one of a fluid power pack and a proportional flow valve; and
actuating an actuator by means of the at least one of the fluid power pack and the proportional flow valve to reciprocate the clamp axis in a linear direction.

9. The method as claimed in claim 8, further comprising:
toggling between a normal mode to an eco-mode and vice versa by means of the human-machine interface,
wherein selecting the eco-mode enables the machine control unit to transmit a first controlling signal to the proportional flow valve and a second controlling signal to the fluid power pack, and
selecting the normal mode enables the machine control unit to transmit the first controlling signal to the proportional flow valve and a derived controlling signal to the fluid power pack.

10. The method as claimed in claim 8, wherein the operating parameter is an operating velocity and the machine control unit generates the pre-set profile of an acceleration and a displacement by means of a formula v=SQRT(2×a×s), where “v” is a velocity, “a” is an acceleration and “s” is a position of the clamp axis.
